(19) United States
(12) Patent Application Publication
(10) Pub. No.: US 2025/0016208 A1
(43) Pub. Date: Jan. 9, 2025

(54) WIRELESS COMMUNICATION SCHEMES FOR SUPPORTING NETWORK SLICING

(71) Applicant: ZTE Corporation, Shenzhen (CN)

(72) Inventors: Menghan WANG, Shenzhen (CN); Jinguo ZHU, Shenzhen (CN); Shuang LIANG, Shenzhen (CN); Xingyue ZHOU, Shenzhen (CN)

(21) Appl. No.: 18/895,099

(22) Filed: Sep. 24, 2024

Related U.S. Application Data
(63) Continuation of application No. PCT/CN2022/114277, filed on Aug. 23, 2022.

(51) Int. Cl. H04L 65/1069; H04L 41/0894; H04L 69/322

(52) U.S. Cl. CPC H04L 65/1069; H04L 41/0894; H04L 69/322

(57) ABSTRACT

A method of wireless communication includes transmitting, by a wireless device to an access and mobility management function, a first message requesting a protocol data unit (PDU) session establishment, the first message including application related information identifying a target application of the wireless device; and receiving, by the wireless device from the access and mobility management function, i) a second message accepting the protocol data unit session establishment, the second message including supported application information, or ii) a third message rejecting the protocol data unit session establishment and including an identification (ID) of an existing PDU session to allow the wireless device to reuse the existing PDU session for the target application.

### CROSS REFERENCE TO RELATED APPLICATIONS

This patent document is a continuation of and claims benefit of priority to International Patent Application No. PCT/CN2022/114277, filed on Aug. 23, 2022. The entire content of the before-mentioned patent application is incorporated by reference as part of the disclosure of this application.

### TECHNICAL FIELD

This document relates to systems, devices and techniques for wireless communications.

### BACKGROUND

Efforts are currently underway to define next generation wireless communication networks that provide greater deployment flexibility, support for a multitude of devices and services and different technologies for efficient bandwidth utilization.

### SUMMARY

Various methods and apparatus for supporting network slicing in a wireless communication system are provided.

In one example aspect, a method of wireless communication is disclosed. The method includes transmitting, by a wireless device to an access and mobility management function, a first message requesting a protocol data unit (PDU) session establishment, the first message including application related information identifying a target application of the wireless device; and receiving, by the wireless device from the access and mobility management function, i) a second message accepting the protocol data unit session establishment, the second message including supported application information, or ii) a third message rejecting the protocol data unit session establishment and including an identification (ID) of an existing PDU session to allow the wireless device to reuse the existing PDU session for the target application.

In another example aspect, another method of wireless communication is disclosed. The method includes receiving, by an access and mobility management function from a wireless device, a first message requesting a protocol data unit (PDU) session establishment to establish a PDU session, the first message including application related information identifying a target application of the wireless device; and transmitting, by the access and mobility management function to the wireless device, i) a second message to accept the PDU session establishment, the second message including supported application information for the PDU session, or ii) a third message to reject the PDU session establishment, the third message including an identification (ID) of an existing PDU session to allow the wireless device to reuse the existing PDU session for the target application.

In yet another example aspect, another method of wireless communication is disclosed.

In yet another example aspect, another method of wireless communication is disclosed.

In yet another example aspect, a wireless communications apparatus comprising a processor is disclosed. The processor is configured to implement methods described herein.

In another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1 shows an example architecture in which various embodiments may be applied.

FIG. 2 shows an existing procures for registering a UE to a set of network slices.

FIG. 3 shows an example process for registering a UE to a set of network slices based on some implementations of the disclosed technology.

FIG. 4 illustrates an example of a PDU session establishment procedure in a non-roaming and local break-out roaming scenario based on some implementations of the disclosed technology.

FIG. 5 illustrates an example of a PDU session establishment procedure in a home-routed roaming scenario based on some implementations of the disclosed technology.

FIG. 6 is a block diagram of an example of a wireless communication apparatus.

FIG. 7 shows an example wireless communications network.

FIGS. 8 and 9 are example flowcharts of wireless communication methods based on some implementations of the disclosed technology.

### DETAILED DESCRIPTION

Section headings are used in the present document only to improve readability and do not limit scope of the disclosed embodiments and techniques in each section only to that section. Furthermore, some embodiments are described with reference to Third Generation Partnership Project (3GPP) New Radio (NR) standard (“5G”) for ease of understanding and the described technology may be implemented in different wireless system that implement protocols other than the 5G protocol.

Network slice has been supported in 5G system, including network slice selection, network slice mapping in roaming scenario, Network Slice Specific Authentication and Authorization (NSSAA), Network Slice Admission Control (NSAC), and so on.

The term, network slice, refers to a logical network that provides specific network capabilities and network characteristics. The term, network slice instance refers to a set of Network Function instances and the required resources (e.g., compute, storage and networking resources) which form a deployed Network Slice.

In the 5G system, it is required that the UE shall be able to support network slice related capabilities. For example, the UE needs to support configured NSSAI, allowed NSSAI, rejected NSSAI, requested NSSAI and pending NSSAI. The configured NSSAI, the allowed NSSAI, the rejected NSSAI, the requested NSSAI, and the pending NSSAI are defined in relevant specifications and each of the configured NSSAI, the allowed NSSAI, the rejected NSSAI, the requested NSSAI, and the pending NSSAI includes one or more S-NSSAIs. Another example is the UE should support UE Route Selection Policy (URSP) and select the most appropriate network slice for the application traffic based on URSP. The UE becomes bottleneck to deploy the network slicing feature because current 5G UE doesn't support network slice related capabilities and it requires complex update and long-term evolution for UE to support network slice related capabilities.

In recognition of the issues above, various implementations of the disclosed technology provide methods to support network slice in network side to reduce UE impacts.

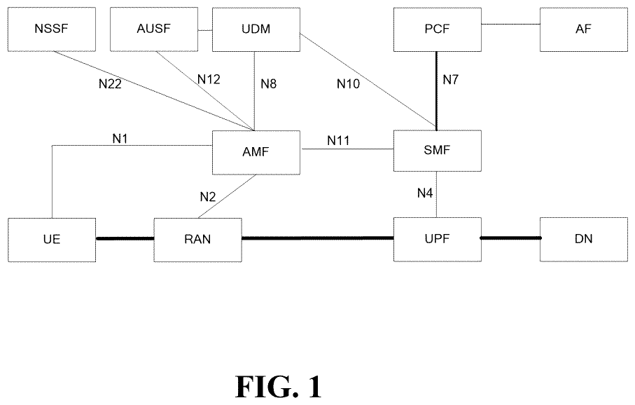

FIG. 1 shows an example architecture in which various embodiments may be applied. The example architecture as shown in FIG. 1 corresponds to a 5G system (5GS) architecture that includes following network functions (NFs):

1) UE, User Equipment.

2) RAN, Radio Access Network.

3) AMF, Access and Mobility Management Function. This NF includes functionalities such as UE Mobility Management, Reachability Management, Connection Management and Registration Management. The AMF terminates the RAN control plane (CP) interface N2 and NAS interface N1, NAS ciphering and integrity protection. It also distributes the SM NAS to the proper SMFs via N11 interface. During Registration procedure, the AMF may determine the allowed NSSAI, the Rejected NSSAI with cause value based on the requested NSSAI received from the UE. The AMF further determines the Registration Area within which the UE can use all S-NSSAIs of the allowed NSSAI. The AMF sends the allowed NSSAI, the rejected NSSAI with cause value and the Registration Area to the UE.

4) UDM, Unified Data Management. This NF manages the subscription profile for the UEs. The subscription data is stored in the Unified Data Repository (UDR). The subscription information includes the network slice related subscription data used for Mobility Management and Session Management. The AMF and SMF retrieve the subscription data from the UDM.

5) NSSF, Network Slice Selection Function. This NF supports the following functionality: selecting the set of Network Slice instances serving the UE; determining the allowed NSSAI and, if needed, the mapping to the home public land mobile network (HPLMN) S-NSSAIs; determining the Configured NSSAI and, if needed, the mapping to the HPLMN S-NSSAIs; determining the AMF Set to be used to serve the UE, or, based on configuration, a list of candidate AMF(s), possibly by querying the Network Repository Function (NRF).

6) SMF, Session Management Function. This NF includes the following functionalities: session establishment, modification and release, UE IP address allocation & management, selection and control of user plane (UP) function, etc.

7) UPF, User Plane Function. This NF serves as an anchor point for intra-/inter-radio access technology (RAT) mobility and as the external PDU session point of interconnect to Data Network (DN). The UPF also routes and forwards the data packet according to the indication from the SMF. It also buffers the downlink (DL) data when the UE is in idle mode.

8) PCF, Policy Control Function. This NF supports unified policy framework to govern network behavior. The PCF provides access management policy to AMF, or session management policy to SMF, or UE policy to the UE. The PCF can access the UDR to obtain the subscription information relevant for policy decisions.

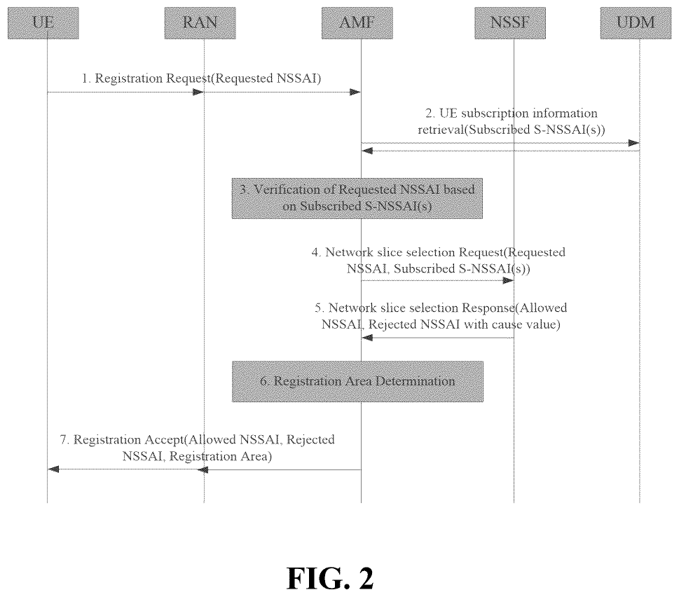

FIG. 2 shows an existing procures for registering a UE to a set of network slices.

Operation 1: When a UE registers over an Access Type with a PLMN, the UE shall provide to the network in NAS layer, a requested NSSAI containing the S-NSSAI(s) corresponding to the slice(s) to which the UE wishes to register.

The requested NSSAI shall be one of:
The Default Configured NSSAI, i.e. if the UE has no Configured NSSAI nor an allowed NSSAI for the serving PLMN;
The Configured-NSSAI, or a subset thereof, e.g., if the UE has no allowed NSSAI for the Access Type for the serving PLMN;
The Allowed-NSSAI for the Access Type over which the requested NSSAI is sent, or a subset thereof; or

The allowed-NSSAI for the Access Type over which the requested NSSAI is sent, or a subset thereof, plus one or more S-NSSAIs from the Configured-NSSAI not yet in the allowed NSSAI for the Access Type.

Operation 2: When the AMF selected by the RAN during Registration Procedure receives the UE Registration request, the AMF may query the UDM to retrieve UE subscription information including the Subscribed S-NSSAIs.

Operation 3: The AMF verifies whether the S-NSSAI(s) in the requested NSSAI are permitted based on the Subscribed S-NSSAIs. To identify the Subscribed S-NSSAIs, the AMF may use the mapped HPLMN S-NSSAIs provided by the UE in the NAS message, for each S-NSSAI of the requested NSSAI.

Operation 4: When the UE context in the AMF does not yet include an allowed NSSAI for the corresponding Access Type, the AMF queries the NSSF for network slice selection, except in the case when the AMF is allowed to determine whether it can serve the UE based on configuration in this AMF. The IP address or FQDN of the NSSF is locally configured in the AMF.

Operation 5: The NSSF returns to the AMF the allowed NSSAI. It may also return the Rejected S-NSSAI(s) with rejection cause indicating the reason why the S-NSSAI(s) has been rejected.

Operation 6: The serving AMF shall determine a Registration Area such that all S-NSSAIs in the allowed NSSAI are available in all Tracking Areas of the Registration Area.

Operation 7: The AMF sends a Registration Accept message to the UE including the Allowed NSSAI and the mapped HPLMN NSSAI of the allowed NSSAI if provided, the Rejected NSSAI and related cause value, and the Registration Area. For rejected NSSAI for the current PLMN, the UE shall not attempt to use this S-NSSAI in the current PLMN. For rejected NSSAI for the current registration area, the UE shall not attempt to use this S-NSSAI in the current registration area.

After completion of the registration procedure, the UE may request to establish a PDU Session. The requested S-NSSAI of the PDU Session is derived from the URSP rules at UE side or UE Local Configuration, and the requested S-NSSAI should be within the allowed NSSAI. The UE shall send the PDU session establishment request including the S-NSSAI to the network.

### Overview of Implementations of Disclosed Technology

In order to use the network slice feature, the UE has to support network slice related capabilities. However, the current 5G UE doesn't support network slice related capabilities and it requires complex update and long-term evolution for UE to support network slice related capabilities. Therefore, various implementations of the disclosed technology provide enhancement of network slice in network side to avoid the UE support of network slice feature.

Some implementations of the disclosed technology suggest the UE registration schemes which allow the UE to register to the network without providing the requested NSSAI from the UE to the network. The network side generates allowed NSSAI based on the subscribed NSSAI, supported NSSAI in the current TA. The network does not provide allowed NSSAI and/or rejected NSSAI to the UE. The AMF may also receive URSP rules from the PCF and store it in UE context.

In the various implementations of the disclosed technology, during a PDU session establishment procedure, the UE provides application related information to the network side (e.g., AMF) so the network side can generate the requested S-NSSAI for the application based on the URSP rule and the allowed NSSAI. The AMF then continue the PDU session establishment procedure as usual.

If the PDU session establishment request is accepted, the AMF may include the supported application information of the PDU session (based on e.g., the URSP rules) in the PDU session establishment accept message sent to the UE. If received, the UE shall match new application information against the supported application information of existing PDU sessions. If there is existing PDU session which can support the new application requirement, the UE shall re-use the existing PDU session for the new application. If there is no existing PDU session which can support the new application requirement, the UE shall initiate PDU session establishment procedure with the new application information sent to network.

If there is existing PDU session that can serve the requested application information based on e.g., the URSP rules, the AMF may reject the PDU Session Establishment request and indicate the PDU session ID that can support the requested application in the PDU session establishment reject message sent to the UE. The UE shall re-use the indicated PDU session for the requested application.

### Implementation Example 1: UE Registration to a Set of Network Slices

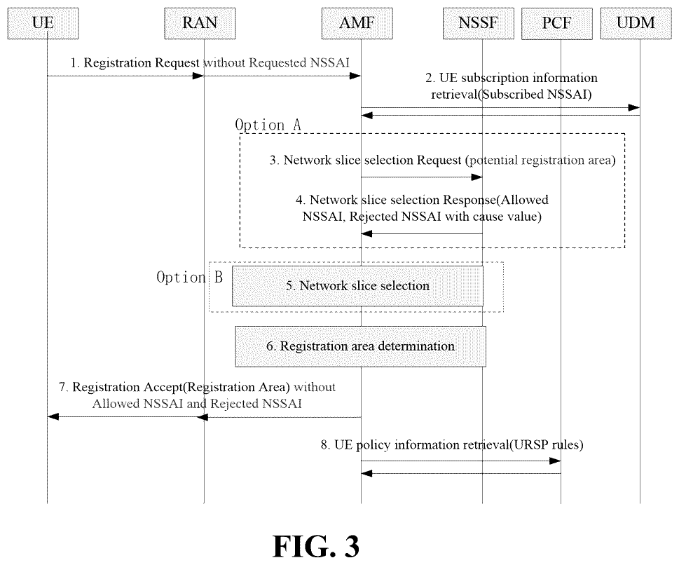

FIG. 3 shows an example process for registering a UE to a set of network slices based on some implementations of the disclosed technology.

Operation 1: When a UE registers over an Access Type with a PLMN, the UE does not provide to the network a requested NSSAI containing the S-NSSAI(s) corresponding to the slice(s) to which the UE wishes to register.

Operation 2: When the network function in charge of access and mobility management (e.g., AMF, AMF is used as example in the following procedures) selected by the RAN during Registration Procedure receives the UE Registration request, the AMF queries the network function which manages subscription profile for UEs (e.g., UDM, UDM is used as example in the following procedures) to retrieve UE subscription information including the Subscribed NSSAI.

After Operation 2, either Option A including Operations 3 and 4 or Option B including Operation 5 proceeds. After Option A or Option B is performed, Operation 6 will be performed.

Option A: There exist another network function which manages network slice selection (e.g., NSSF, NSSF is used as example in the following procedures).

Operation 3: The AMF queries the NSSF for network slice selection with e.g., Subscribed NSSAI, UE current location, potential registration area as input. The potential registration area includes a list of TAI(s) that the AMF intends to include in the registration area. The IP address or FQDN of the NSSF is locally configured in the AMF.

Operation 4: The NSSF returns to the AMF the allowed NSSAI considering e.g., the Subscribed NSSAI of the UE, current location of the UE, the supported NSSAI of current TA, the potential registration area, the supported NSSAI of potential registration area. The NSSF may also return the Rejected NSSAI with rejection cause indicating the reason why the S-NSSAI has been rejected. Since the UE did not provide requested NSSAI in the registration request message, the allowed NSSAI and the Rejected NSSAI are generated without taking requested NSSAI into account. In roaming scenario, the allowed NSSAI and the rejected NSSAI include serving PLMN S-NSSAI and corresponding mapped HPLMN S-NSSAI.

Option B: AMF manages network slice selection.

Operation 5: If the AMF is allowed to determine network slice selection based on configuration, the AMF generates the Allowed NSSAI and the Rejected NSSAI based on e.g., the Subscribed NSSAI, UE current location, the supported NSSAI of current TA, the potential registration area, and the supported NSSAI of potential Registration Area. Since the UE did not provide requested NSSAI in the registration request message, the Allowed NSSAI and the Rejected NSSAI are generated without taking requested NSSAI into account. In roaming scenario, the allowed NSSAI and the rejected NSSAI include serving PLMN S-NSSAI and corresponding mapped HPLMN S-NSSAI.

Operation 6: The serving AMF shall determine a Registration Area such that all S-NSSAIs in the allowed NSSAI are available in all Tracking Areas of the Registration Area. The AMF stores the allowed NSSAI, the Rejected NSSAI and the Registration Area of the UE.

Operation 7: The AMF sends a Registration Accept message to the UE which includes the Registration Area but does not include the allowed NSSAI and the Rejected NSSAI.

Operation 8: The AMF queries the network function in charge of policy control (e.g., PCF, PCF is used as example in the following procedures) to retrieve UE policy information including the UE Route Selection Policy (URSP) rules. The AMF stores the URSP rules in the UE context.

### Implementation Example 2: PDU Session Establishment Procedure in Non-Roaming and Local Break-Out Roaming Scenario

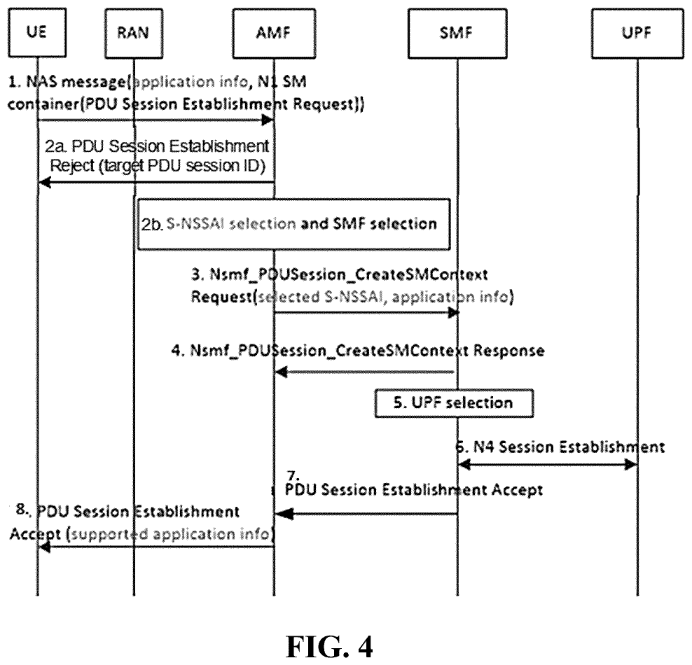

FIG. 4 illustrates an example of a PDU session establishment procedure in non-roaming and local break-out roaming scenario. After the UE registers to network as discussed with regard to FIG. 3, the UE can request PDU session establishment.

Operation 1 from UE to AMF: NAS Message (PDU Session ID, Request type, UE requested DNN, application related information, N1 SM container (PDU Session Establishment Request)).

The PDU Session Establishment Request is included in the NAS message and encapsulated in the N1 SM container, which will be transparently forwarded to the network function in charge of session management (e.g., SMF, SMF is used as example in the following procedures). The NAS message sent by the UE is encapsulated by the RAN in a N2 message towards the AMF.

The NAS message sent by the UE does not include S-NSSAI related to the PDU session. The NAS message includes application related information that identifies a target application of the UE. The target application may refer to the application which needs to obtain connectivity through the PDU session establishment. In some implementations, the application related information includes, e.g., application descriptors, IP (Internet Protocol) descriptors, DNNs (Data Network Names), connection capabilities. The connection capabilities may indicate “ims”, “mms”, “internet”, etc. The application related information doesn't include S-NSSAI information. The PDU Session Establishment Request in the N1 SM container may also include the application related information. If the application related information is also included in the PDU Session Establishment Request, then the AMF shall not forward the received application related information to the SMF. If the application related information is not included in the PDU Session Establishment Request, the AMF may forward the received application related information to the SMF.

After Operation 1, either Operation 2a or Operation 2b is performed.

Operation 2a: AMF to UE: PDU Session Establishment Reject (target PDU session ID)

The AMF may determine whether there is an existing PDU session that can serve the application related information corresponding to the target application. If there is an existing PDU session that can serve the application related information corresponding to the target application based on e.g., the URSP rules, the AMF may reject the PDU session establishment request by sending the PDU session establishment reject message to the UE. In this case, the AMF may indicate the PDU session ID that can support the target application in the PDU session establishment reject message sent to the UE. The UE shall re-use the indicated PDU session for the target application.

Operation 2b: If there is no existing PDU session that can serve the application related information corresponding to the target application, the AMF selects a proper S-NSSAI from the allowed NSSAI based on, e.g., the received application related information, the URSP rules and UE subscription information. Then the AMF selects a proper SMF to serve the PDU session, based on e.g., the selected S-NSSAI, the application related information, the URSP rules. The AMF stores the association of the selected S-NSSAI, the PDU session ID, the SMF ID, etc.

Operation 3: AMF to SMF: Nsmf_PDUSession_CreateSMContext Request (selected S-NSSAI, application related information, PDU Session ID, AMF ID, Request Type, N1 SM container (PDU Session Establishment Request), User location information). The Nsmf_PDUSession_CreateSMContext Request corresponds to a request to create ‘SM (Session Management) Context’ service operation for a given PDU session in the SMF.

The AMF sends the selected S-NSSAI to the SMF. The AMF may forward the received application related information to the SMF.

Operation 4: SMF to AMF: Nsmf_PDUSession_CreateSMContext Response (SM Context ID). The SM Context ID identifies the SM context created in the SMF for the UE.

Operation 5: The SMF selects a user plane function (e.g., UPF, UPF is used as example in the following procedures) to serve the PDU session, based on e.g., the UE location, the selected S-NSSAI and the application related information.

Operation 6. The SMF initiates an N4 Session Establishment procedure with the selected UPF.

Operation 7: SMF to AMF: PDU Session Establishment Accept

If the connectivity with the requested DN is accepted by the network, the SMF shall create a PDU session establishment accept message.

Operation 8: AMF to UE: PDU Session Establishment Accept (supported application information)

If the PDU Session Establishment request is accepted, the N2 SM information carries information that the AMF shall forward to the RAN, including the selected S-NSSAI. The N1 SM container contains the PDU Session Establishment Accept that the AMF shall provide to the UE, which does not include the S-NSSAI information.

The AMF may include the supported application information of the PDU session (based on e.g., the URSP rules) in the PDU session establishment accept message sent to the UE. The supported application information of the PDU session does not include S-NSSAI information. The AMF shall store the supported application information of the PDU session.

After receiving the PDU session establishment accept message with supported application information, there are new application traffic that requires transmission and may trigger PDU session establishment. The new application traffic may be referred to as the requested application information. The UE shall determine whether there is an existing PDU session whose supported application information matches the request application information. If there is an existing PDU session whose supported application information matches the request application information, the UE shall re-use the existing PDU session for the target application. If there is no existing PDU session whose supported application information matches the requested application information, the UE shall initiate a PDU session establishment procedure with the application related information sent to network.

### Implementation Example 3: PDU Session Establishment Procedure in Home-Routed Roaming Scenario

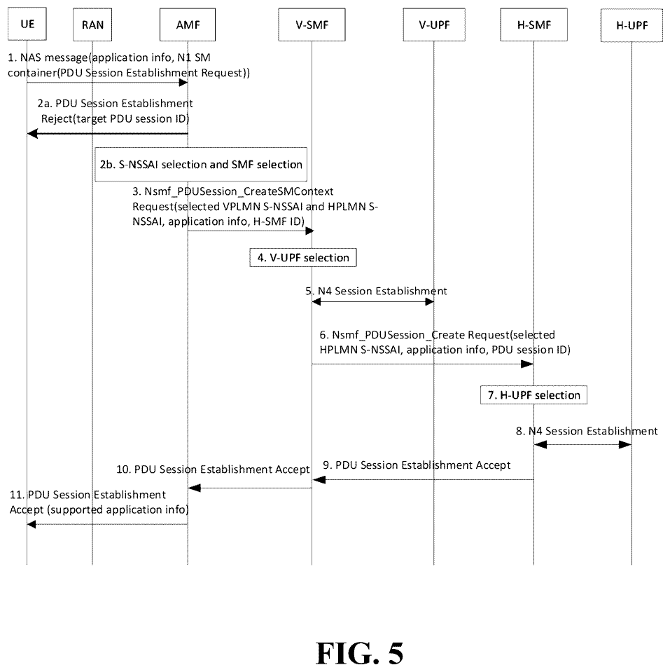

FIG. 5 illustrates a PDU session establishment procedure in home-routed roaming scenario. After UE registers to network as discussed with regard to FIG. 3, the UE can request PDU session establishment.

Operation 1: UE to AMF: NAS Message (PDU Session ID, Request type, UE requested DNN, application related information, N1 SM container (PDU Session Establishment Request)).

The PDU Session Establishment Request is included in the NAS message and encapsulated in the N1 SM container, which will be transparently forwarded to SMF. The NAS message sent by the UE is encapsulated by the RAN in a N2 message towards the AMF.

The NAS message sent by the UE does not include S-NSSAI related to the PDU session. The NAS message includes application related information that identifies a target application of the UE. The target application may refer to the application which needs to obtain connectivity through the PDU session establishment. In some implementations, the application related information includes, e.g., application descriptors, IP descriptors, DNNs, connection capabilities. Connection capabilities may indicate “ims”, “mms”, “internet”, etc. The application related information doesn't include S-NSSAI information. The PDU Session Establishment Request in the N1 SM container may also include the application related information. If the application related information is also included in the PDU Session Establishment Request, then the AMF shall not forward the received application related information to the SMF. If the application related information is not included in the PDU Session Establishment Request, the AMF may forward the received application related information to the SMF.

After Operation 1, either Operation 2a or Operation 2b is performed.

Operation 2a: AMF to UE: PDU Session Establishment Reject (target PDU session ID)

The AMF may determine whether there is an existing PDU session that can serve the application related information corresponding to the target application. If there is an existing PDU session that can serve the application related information corresponding to the target application based on e.g., the URSP rules, the AMF may reject the PDU session establishment request by sending the PDU session establishment reject message to the UE. In this case, the AMF may indicate the PDU session ID that can support the target application in the PDU session establishment reject message sent to the UE. The UE shall re-use the indicated PDU session for the target application.

Operation 2b: If there is no existing PDU session that can serve the application related information corresponding to the target application, the AMF selects a mapped HPLMN S-NSSAI from the mapped NSSAI of the allowed NSSAI and the corresponding serving PLMN S-NSSAI based on, e.g., the received application related information, the URSP rules and UE subscription information.

Then, the AMF selects a V-SMF to serve the PDU session, based on, e.g., the selected serving PLMN S-NSSAI, the application related information, the URSP rules.

The AMF also selects a H-SMF to serve the PDU session, based on, e.g., the selected HPLMN S-NSSAI, the application related information, the URSP rules.

The AMF stores the association of the selected S-NSSAI(s), the PDU session ID, the V-SMF ID, the H-SMF ID, etc.

Operation 3: AMF to V-SMF: Nsmf_PDUSession_CreateSMContext Request (VPLMN S-NSSAI, mapped HPLMN S-NSSAI, H-SMF ID, application related information, PDU Session ID, AMF ID, Request Type, N1 SM container (PDU Session Establishment Request), User location information).

The AMF sends the selected serving PLMN S-NSSAI and corresponding mapped HPLMN S-NSSAI to the V-SMF. The AMF provides the identity of the selected H-SMF. The AMF may forward the received application related information to the V-SMF.

Operation 4: The V-SMF selects a V-UPF to serve the PDU session, based on, e.g., the UE location, the selected VPLMN S-NSSAI and the application related information.

Operation 5: The V-SMF initiates an N4 Session Establishment procedure with the selected V-UPF.

Operation 6: V-SMF to H-SMF: Nsmf_PDUSession_Create Request (SUPI, PDU Session ID, HPLMN S-NSSAI, application related information, V-SMF ID, AMF ID)

The V-SMF sends the selected HPLMN S-NSSAI to the H-SMF. The V-SMF may forward the received application related information to the H-SMF.

Operation 7: The H-SMF selects a H-UPF to serve the PDU session, based on, e.g., the UE location, the selected HPLMN S-NSSAI and the application related information.

Operation 8: The H-SMF initiates an N4 Session Establishment procedure with the selected H-UPF.

Operation 9: H-SMF to V-SMF: PDU Session Establishment Accept

Operation 10: V-SMF to AMF: PDU Session Establishment Accept

Operation 11: AMF to UE: PDU Session Establishment Accept (supported application information)

If the PDU Session Establishment request is accepted, the N2 SM information carries information that the AMF shall forward to the RAN, including the selected VPLMN S-NSSAI and corresponding mapped HPLMN S-NSSAI. The N1 SM container contains the PDU Session Establishment Accept that the AMF shall provide to the UE, which does not include the S-NSSAI information.

The AMF may include the supported application information of the PDU session (based on, e.g., the URSP rules) in the PDU session establishment accept message sent to the UE. The supported application information of the PDU session does not include S-NSSAI information. After receiving the PDU session establishment accept message with supported application information, there are new application traffic that requires transmission and may trigger PDU session establishment. The new application traffic may be referred to as the requested application information. The UE shall determine whether there is an existing PDU session whose supported application information matches the requested application information. If there is an existing PDU session whose supported application information matches the request application information, the UE shall re-use the existing PDU session for the target application. If there is no existing PDU session whose supported application information matches the request application information, the UE shall initiate a PDU session establishment procedure with the application related information sent to network.

In this patent document, various solutions to support one or more network slices are provided. Some aspects from the UE, AMF, and PCF can include one or more features summarized as follows:
The UE is configured to perform at least one of following operations:
Sending PDU session establishment request with application related information to AMF.

In some implementations, the application related information includes application descriptors and/or IP descriptors and/or DNNs and/or connection capabilities and/or other information describing the traffic that requires PDU session transmission. The connection capabilities may indicate “ims”, “mms”, “internet”, etc. The application related information doesn't include S-NSSAI information.
Receiving a PDU session establishment acceptance including supported application information of the PDU session from AMF. After receiving the PDU session establishment acceptance with the supported application information, there is new application traffic that requires transmission. The new application traffic may be referred to as the requested application information. The UE shall determine whether there is an existing PDU session whose supported application information matches the requested application information.
Receiving a PDU session establishment rejection including target PDU session ID from AMF. After receiving the PDU session establishment rejection with target PDU session ID, the UE shall re-use the indicated PDU session for the requested application.

The AMF is configured to perform at least one of following operations:
Receiving UE policy information including UE route selection policy (URSP) rules from PCF and storing it in a UE context.
Receiving PDU session establishment request with application related information from UE.

In some implementations, the application related information includes application descriptors and/or IP descriptors and/or DNNs and/or connection capabilities and/or other information describing the traffic that requires PDU session transmission. The connection capabilities may indicate “ims”, “mms”, “internet”, etc. The application related information doesn't include S-NSSAI information.
Selecting a serving PLMN S-NSSAI and corresponding mapped HPLMN S-NSSAI in a roaming case from allowed NSSAI for the PDU session based on the received application related information and the URSP rule.
Sending PDU session establishment accept including supported application information of the PDU session to UE and storing the supported application information of the PDU session.
Sending PDU session establishment reject including target PDU session ID to UE.

### PCF

Sending UE policy information including UE route selection policy (URSP) rules to AMF.

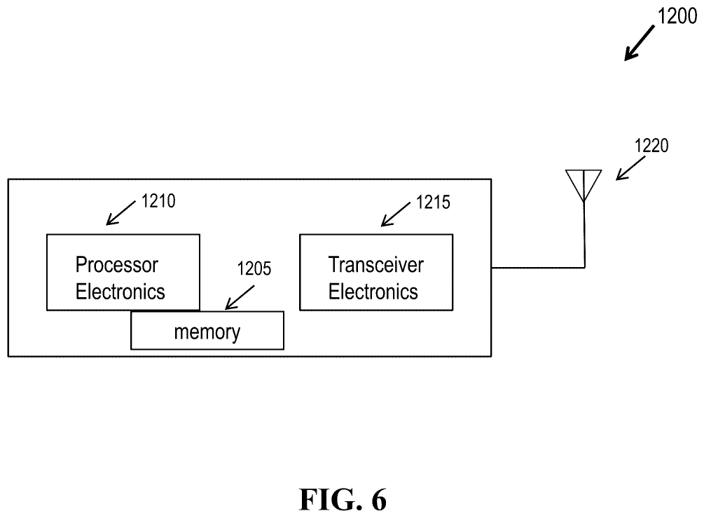

FIG. 6 is a block diagram of an example implementation of a wireless communication apparatus 1200. The methods described herein may be implemented by the apparatus 1200. In some embodiments, the apparatus 1200 may be a base station or a network device of a wireless network. In some embodiments, the apparatus 1200 may be a user device (e.g., a wireless device or a user equipment UE). The apparatus 1200 includes one or more processors, e.g., processor electronics 1210, transceiver circuitry 1215 and one or more antenna 1220 for transmission and reception of wireless signals. The apparatus 1200 may include memory 1205 that may be used to store data and instructions used by the processor electronics 1210. The apparatus 1200 may also include an additional network interface to one or more core networks or a network operator's additional equipment. This additional network interface, not explicitly shown in the figure, may be wired (e.g., fiber or Ethernet) or wireless.

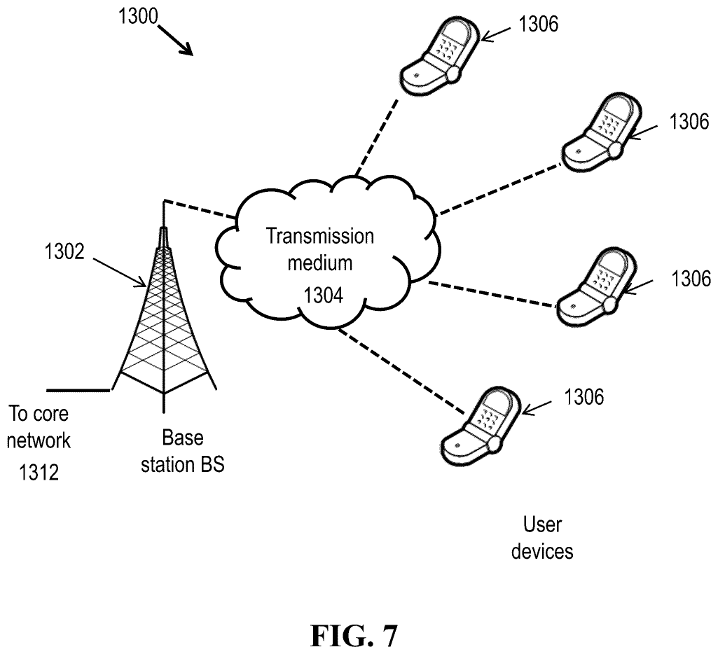

FIG. 7 depicts an example of a wireless communication system 1300 in which the various techniques described herein can be implemented. The system 1300 includes a base station 1302 that may have a communication connection with core network (1312) and to a wireless communication medium 1304 to communicate with one or more user devices 1306. The user devices 1306 could be smartphones, tablets, machine to machine communication devices, Internet of Things (IoT) devices, and so on.

Some preferred embodiments may include the following solutions.

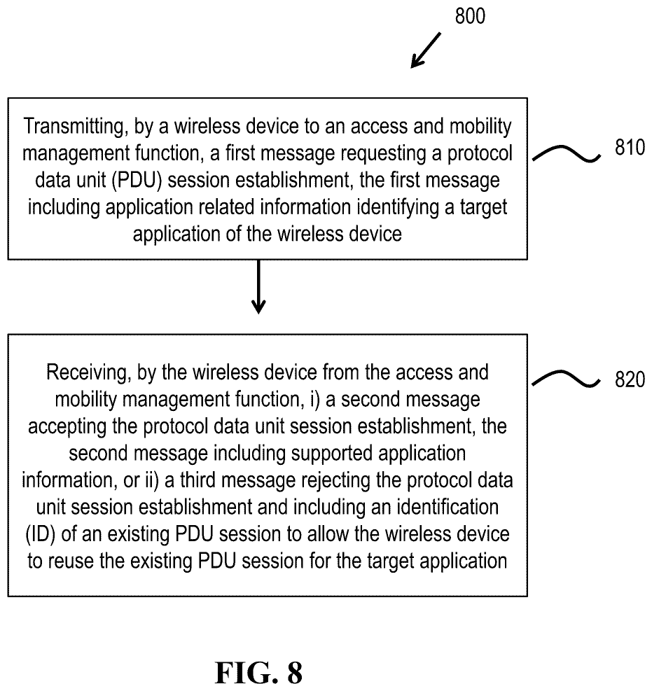

1. A method (e.g., method 800 as shown in FIG. 8) of wireless communication, comprising: transmitting 810, by a wireless device to an access and mobility management function, a first message requesting a protocol data unit (PDU) session establishment, the first message including application related information identifying a target application of the wireless device; and receiving 820, by the wireless device from the access and mobility management function, i) a second message accepting the protocol data unit session establishment, the second message including supported application information, or ii) a third message rejecting the protocol data unit session establishment and including an identification (ID) of an existing PDU session to allow the wireless device to reuse the existing PDU session for the target application.

2. The method of solution 1, wherein the application related information includes at least one of one or more application descriptors, one or more internet protocol (IP) descriptors, one or more data network names (DNNs), one or more connection capabilities, or other information describing application traffic that requires PDU session transmission.

3. The method of solution 1, wherein the first message, the second message and the third message do not include a single network slice selection assistance information (S-NSSAI) that identifies a network slice.

4. The method of solution 1, further comprising: determining, after receiving the second message, whether there is an existing PDU session that supports a requested application information related to application traffic triggering a PDU session establishment; and reusing the existing PDU session for the requested application in case that there is the existing PDU session or initiating a PDU session establishment procedure with the requested application information.

5. The method of solution 1, further comprising: transmitting, by the wireless device to the access and mobility management function, a registration request to register the wireless device over an access type with a mobile network, the registration request omitting a requested network slice selection assistance information (NSSAI) containing one or more S-NSSAIs corresponding to one or more slices to which the wireless device requests to register; and receiving, by the wireless device from the access and mobility management function, a registration acceptance that omits an allowed NSSAI and a rejected NSSAI.

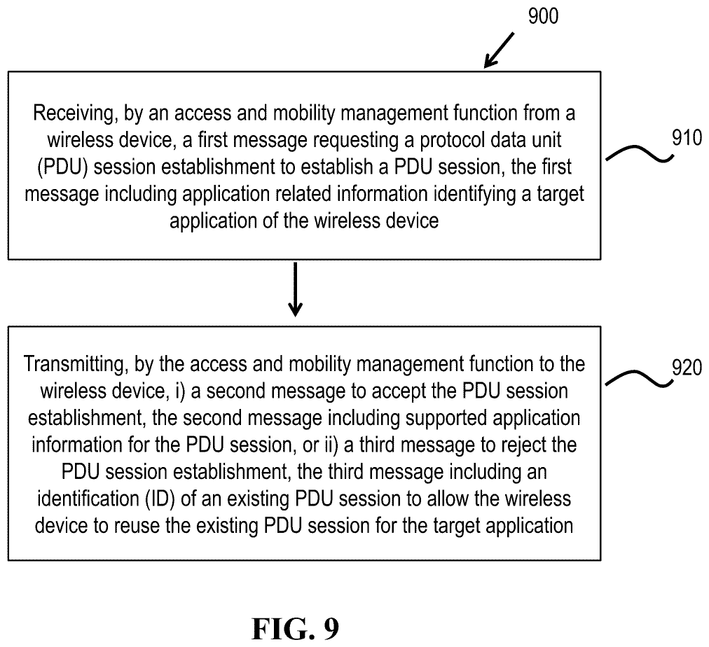

6. A method of wireless communication (e.g., method 900 as shown in FIG. 9), comprising: receiving 910, by an access and mobility management function from a wireless device, a first message requesting a protocol data unit (PDU) session establishment to establish a PDU session, the first message including application related information identifying a target application of the wireless device; and transmitting 920, by the access and mobility management function to the wireless device, i) a second message to accept the PDU session establishment, the second message including supported application information for the PDU session, or ii) a third message to reject the PDU session establishment, the third message including an identification (ID) of an existing PDU session to allow the wireless device to reuse the existing PDU session for the target application.

7. The method of solution 6, wherein the application related information includes at least one of one or more application descriptors, one or more an internet protocol (IP) descriptors, one or more data network names (DNNs), one or more connection capabilities, or other information describing application traffic that requires PDU session transmission.

8. The method of solution 6, wherein the first message, the second message, and the third message do not include a single network slice selection assistance information (S-NSSAI) that identifies a network slice.

9. The method of solution 6, further comprising: selecting, by the access and mobility management function, a single network slice selected assistance information (S-NSSAI) from S-NSSAIs in an allowed NSSAI based on at least one of the application related information, UE route selection policy (URSP) rules, or subscription information of the wireless device.

10. The method of solution 9, further comprising: selecting, by the access and mobility management function, a session management function based on at least one of the selected S-NSSAI, the application related information, or UE route selection policy (URSP) rules.

11. The method of solution 10, further comprising: transmitting, by the access and mobility management function to the session management function, a request to create a SM context, the request including the application related information that allows the session management function to select a user plane function to serve the PDU session based on at least one of a location of the wireless device, the selected S-NSSI, or the application related information.

12. The method of solution 6, further comprising before the transmitting of the second message: adding, by the access and mobility management function, the supported application information of the PDU session to the second message.

13. The method of solution 6, further comprising: storing, by the access and mobility management function, the supported application information of the PDU session.

14. The method of solution 6, further comprising: determining, by the access and mobility management function, whether there is an existing PDU session that supports a requested application information related to application traffic triggering a PDU session establishment, and wherein the third message is transmitted in response to the determining that there is the existing PDU session that supports the requested application information.

15. The method of solution 6, further comprising: transmitting, by the access and mobility management function to a network slice selection function, a query regarding a network slice selection based on at least one of a subscribed NSSAI, a location of the wireless device, or a potential registration area including a list of tracking area identities (TAIs); and receiving, by the access and mobility management function from the network slice selection function, an allowed NSSAI and a rejected NSSI that are generated without considering a requested NSSAI.

16. The method of solution 6, further comprising: generating, by the access and mobility management function, an allowed NSSAI and a rejected NSSAI based on at least one of a subscribed NSSAI, a location of the wireless device, a supported NSSAI of a current tracking area (TA), a potential registration area, or a supported NSSAI of the potential registration area, wherein the allowed NSSAI and the rejected NSSAI are generated without considering a requested NSSAI.

17. The method of solution 6, further comprising: transmitting, by the access and mobility management function to a policy control function, a query to retrieve policy information for the wireless device, the policy information including UE route selection policy (URSP) rules; and storing, by the access and mobility management function, the URSP rules for the wireless device in a context of the wireless device.

18. The method of solution 6, further comprising: selecting, by the access and mobility management function, a home public land mobile network (HPLMN)S-NSSAI and a corresponding serving public land mobile network (VPLMN)S-NSSAI based on at least one of the application related information, UE route selection policy (URSP) rules, or subscription information of the wireless device.

19. A wireless communication apparatus comprising a processor configured to implement a method recited in any of solutions 1-18.

20. A computer storage medium having code stored thereupon, the code, upon execution by a processor, causing the processor to implement a method recited in any of solutions 1-18.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
transmitting, by a wireless device to an access and mobility management function, a first message requesting a protocol data unit (PDU) session establishment, the first message including application related information identifying a target application of the wireless device; and
receiving, by the wireless device from the access and mobility management function, i) a second message accepting the protocol data unit session establishment, the second message including supported application information, or ii) a third message rejecting the protocol data unit session establishment and including an identification (ID) of an existing PDU session to allow the wireless device to reuse the existing PDU session for the target application.

2. The method of claim 1, wherein the application related information includes at least one of one or more application descriptors, one or more internet protocol (IP) descriptors, one or more data network names (DNNs), one or more connection capabilities, or other information describing application traffic that requires PDU session transmission.

3. The method of claim 1, wherein the first message, the second message and the third message do not include a single network slice selection assistance information (S-NSSAI) that identifies a network slice.

4. The method of claim 1, further comprising:
determining, after receiving the second message, whether there is an existing PDU session that supports a requested application information related to application traffic triggering a PDU session establishment; and
reusing the existing PDU session for the requested application in case that there is the existing PDU session or initiating a PDU session establishment procedure with the requested application information.

5. The method of claim 1, further comprising:
transmitting, by the wireless device to the access and mobility management function, a registration request to register the wireless device over an access type with a mobile network, the registration request omitting a requested network slice selection assistance information (NSSAI) containing one or more S-NSSAIs corresponding to one or more slices to which the wireless device requests to register; and
receiving, by the wireless device from the access and mobility management function, a registration acceptance that omits an allowed NSSAI and a rejected NSSAI.

6. A method of wireless communication, comprising:
receiving, by an access and mobility management function from a wireless device, a first message requesting a protocol data unit (PDU) session establishment to establish a PDU session, the first message including application related information identifying a target application of the wireless device; and
transmitting, by the access and mobility management function to the wireless device, i) a second message to accept the PDU session establishment, the second message including supported application information for the PDU session, or ii) a third message to reject the PDU session establishment, the third message including an identification (ID) of an existing PDU session to allow the wireless device to reuse the existing PDU session for the target application.

7. The method of claim 6, wherein the application related information includes at least one of one or more application descriptors, one or more an internet protocol (IP) descriptors, one or more data network names (DNNs), one or more connection capabilities, or other information describing application traffic that requires PDU session transmission.

8. The method of claim 6, wherein the first message, the second message, and the third message do not include a single network slice selection assistance information (S-NSSAI) that identifies a network slice.

9. The method of claim 6, further comprising:
selecting, by the access and mobility management function, a single network slice selected assistance information (S-NSSAI) from S-NSSAIs in an allowed NSSAI based on at least one of the application related information, UE route selection policy (URSP) rules, or subscription information of the wireless device, and/or
storing, by the access and mobility management function, the supported application information of the PDU session.

10. The method of claim 9, further comprising:
selecting, by the access and mobility management function, a session management function based on at least one of the S-NSSAI, the application related information, or UE route selection policy (URSP) rules, and
transmitting, by the access and mobility management function to the session management function, a request to create a SM context, the request including the application related information that allows the session management function to select a user plane function to serve the PDU session based on at least one of a location of the wireless device, the selected S-NSSI, or the application related information.

11. The method of claim 6, further comprising before the transmitting of the second message:
adding, by the access and mobility management function, the supported application information of the PDU session to the second message.

12. The method of claim 6, further comprising:
determining, by the access and mobility management function, whether there is an existing PDU session that supports a requested application information related to application traffic triggering a PDU session establishment, and
wherein the third message is transmitted in response to the determining that there is the existing PDU session that supports the requested application information.

13. The method of claim 6, further comprising:
transmitting, by the access and mobility management function to a network slice selection function, a query regarding a network slice selection based on at least one of a subscribed NSSAI, a location of the wireless device, or a potential registration area including a list of tracking area identities (TAIs); and
receiving, by the access and mobility management function from the network slice selection function, an allowed NSSAI and a rejected NSSI that are generated without considering a requested NSSAI.

14. The method of claim 6, further comprising:
Generating, by the access and mobility management function, an allowed NSSAI and a rejected NSSAI based on at least one of a subscribed NSSAI, a location of the wireless device, a supported NSSAI of a current tracking area (TA), a potential registration area, or a supported NSSAI of the potential registration area, wherein the allowed NSSAI and the rejected NSSAI are generated without considering a requested NSSAI, and/or
selecting, by the access and mobility management function, a home public land mobile network (HPLMN)S-NSSAI and a corresponding serving public land mobile network (VPLMN) S-NSSAI based on at least one of the application related information, UE route selection policy (URSP) rules, or subscription information of the wireless device.

15. The method of claim 6, further comprising:
transmitting, by the access and mobility management function to a a policy control function, a query to retrieve policy information for the wireless device, the policy information including UE route selection policy (URSP) rules; and
storing, by the access and mobility management function, the URSP rules for the wireless device in a context of the wireless device.

16. A wireless communication apparatus comprising a processor operating as a wireless device to an access and mobility management function and configured to:
transmit a first message requesting a protocol data unit (PDU) session establishment, the first message including application related information identifying a target application of the wireless device; and
receive i) a second message accepting the protocol data unit session establishment, the second message including supported application information, or ii) a third message rejecting the protocol data unit session establishment and including an identification (ID) of an existing PDU session to allow the wireless device to reuse the existing PDU session for the target application.

17. The wireless communication apparatus of claim 16, wherein the application related information includes at least one of one or more application descriptors, one or more internet protocol (IP) descriptors, one or more data network names (DNNs), one or more connection capabilities, or other information describing application traffic that requires PDU session transmission, or wherein the first message, the second message and the third message do not include a single network slice selection assistance information (S-NSSAI) that identifies a network slice.

18. The wireless communication apparatus of claim 16, wherein the processor is further configured to:
determine, after receiving the second message, whether there is an existing PDU session that supports a requested application information related to application traffic triggering a PDU session establishment; and
reuse the existing PDU session for the requested application in case that there is the existing PDU session or initiating a PDU session establishment procedure with the requested application information.

19. The wireless communication apparatus of claim 16, wherein the processor is further configured to:
transmit a registration request to register the wireless device over an access type with a mobile network, the registration request omitting a requested network slice selection assistance information (NSSAI) containing one or more S-NSSAIs corresponding to one or more slices to which the wireless device requests to register; and
receive a registration acceptance that omits an allowed NSSAI and a rejected NSSAI.

20. The wireless communication apparatus of claim 16, wherein the processor is further configured to:
receive a first message requesting a protocol data unit (PDU) session establishment to establish a PDU session, the first message including application related information identifying a target application of the wireless device; and
transmit i) a second message to accept the PDU session establishment, the second message including supported application information for the PDU session, or ii) a third message to reject the PDU session establishment, the third message including an identification (ID) of an existing PDU session to allow the wireless device to reuse the existing PDU session for the target application.
